(19) United States
(12) Patent Application Publication
(10) Pub. No.: US 2017/0258037 A1
(43) Pub. Date: Sep. 14, 2017

(54) Collapsible Pet Bed with Removably Attachable Cover

(71) Applicant: Focus Products Group International, LLC, Lincolnshire, IL (US)

(72) Inventor: Brenda K. Miller, Jersey Shore, PA (US)

(21) Appl. No.: 15/138,762

(22) Filed: Apr. 26, 2016

Related U.S. Application Data
(63) Continuation-in-part of application No. 15/063,981, filed on Mar. 8, 2016.

(51) Int. Cl. A01K 1/035; A01K 29/00

(52) U.S. Cl. CPC A01K 1/0353; A01K 29/00

(57) ABSTRACT

A pet bed has a tubular member of pliant material. The tubular member has first and second surfaces, one of which defines an outer surface and the other of which defines an inner surface. The tubular member has axially opposite first and second ends spaced apart by a length. The first end forms an opening in the interior. One of the tubular member first and second surfaces has a plurality of stay attachment members with stays disposed within the stay attachments. The tubular member is folded over itself to form an upstanding wall with the first end adjacent to the second end, an intermediate portion of the tubular member spaced from the first and second ends, a portion first surface facing outward and another portion of the first surface facing inward to define an interior of the pet bed, and portions of the second surface facing another each other.

### RELATED APPLICATION DATA

This application is a continuation-in-part of application Ser. No. 15/063,981, filed on Mar. 8, 2016, currently pending, the disclosure of which is incorporated by reference herein.

### BACKGROUND AND SUMMARY

The present disclosure relates to a collapsible pet bed having a removably attachable cover. The pet bed has a frame which is collapsible and the cover extends over at least a portion of the inward faces of the frame and over at least a portion of the outward faces of the frame. The cover may be cushioned. The collapsible pet bed and its components, including the cover, may be stored in the carrying tote thereby allowing the pet bed to be portable.

### BRIEF DESCRIPTION OF THE DRAWINGS

FIG. 1 shows an exploded view of the components of the pet bed including a cushion, a base, a frame (in a collapsed arrangement), and a cover.

FIG. 2 shows an exploded view of the frame being installed with the cover.

FIG. 3 shows the assembly of the cover and the frame.

FIG. 4 shows a cross-sectional view of the cover installed around the frame providing detail of one manner in which the cover may be releasably attached to the pet bed.

FIG. 5 shows an exploded view of the pet bed with the base and cushion being installed in an interior of the frame.

FIG. 6 shows the assembled pet bed of FIG. 5 with the cover extending around the frame, and the base and cushion installed in the interior of the frame.

FIG. 7 shows the cover, the frame, the cushion, and the base in a collapsed, side-by-side arrangement prior to their insertion in a carrying tote.

FIG. 8 shows a front perspective view of an alternate embodiment of a pet bed.

FIG. 9 is a cut-away, perspective view of the pet bed of FIG. 8.

FIG. 10 shows a rear perspective view of the pet bed of FIG. 8.

FIG. 11 is a cut-away, perspective view of the pet bed of FIG. 8.

FIG. 12 is an exploded view of the pet bed of FIG. 8 with one embodiment of a base and cushion.

FIG. 13 is an exploded view of the pet bed of FIG. 8 with an alternate embodiment of a base and cushion.

FIG. 14 shows an alternate embodiment of a pet bed.

### DETAILED DESCRIPTION

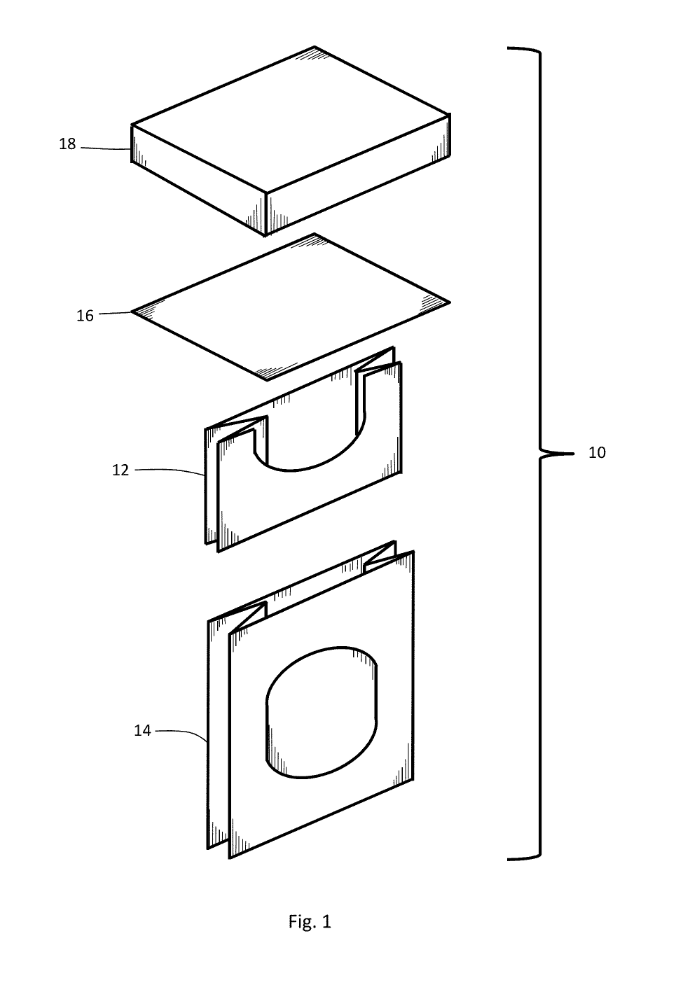

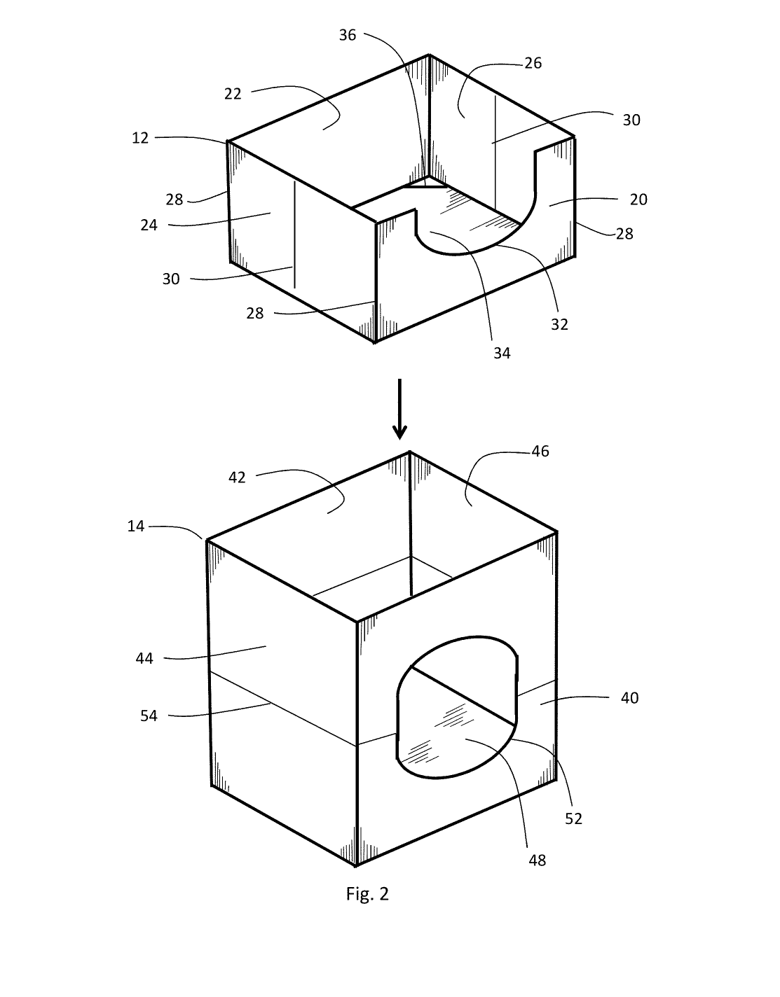

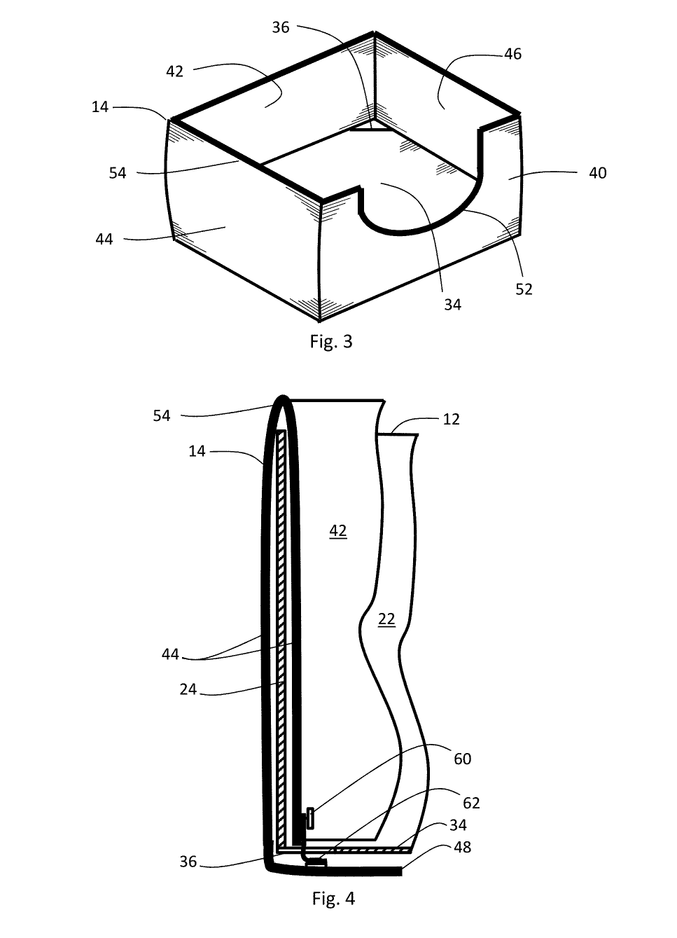

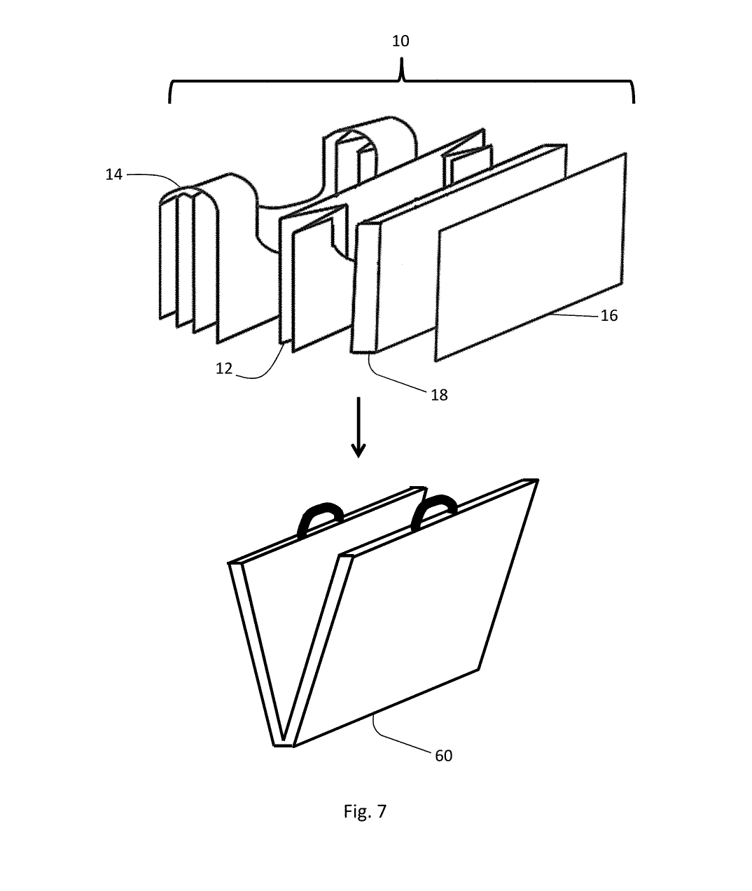

The terms left and right, front and rear, and bottom and top are used for ease of illustration in explaining features appearing in the drawings and are not to be construed in a way to limit the disclosure. FIG. 1 shows an exploded view of the components of a pet bed 10 including a frame 12 (in a collapsed arrangement), a cover 14, a base 16, and a cushion 18. FIG. 2 shows the frame in a somewhat expanded arrangement. As will be explained below in greater detail, to allow the frame 12 to fit within the cover 14, the frame may be fully expanded once inserted in the cover. The frame 12 comprises front and rear walls 20,22, and left and right side walls 24,26. The left and right side walls 24,26, and the front and rear walls 20,22 may be formed from a light weight, rigid planar material, for instance, plastic, vinyl, corrugated paperboard, cardboard, plastic. The front and rear walls 20,22 may have a pivot connection 28 with each of the left and right side walls 24,26 at corners of the frame. By way of example, the connection of the front and rear walls 20,22 to the left and right side walls 24,26 may be via a live hinge, a line of weakness, or fold line, or may be via mechanical hinge, for instance, a piano type hinge. The left and right side walls 24,26 may have a similar type of wall pivot connection 30, for instance, a vertical fold line or live hinge between the connection with the front and rear walls. As shown in the drawings, the wall pivot connection 30 is centered in each of the left and right side walls. The left and right side wall pivot connection 30, e.g., fold line, may allow portions of the left and right side walls 24,26 to be pivoted inward, thereby allowing the pet bed to be moved between a collapsed and an expanded arrangement. In the collapsed arrangement, the front and rear walls 20,22 and the left and right side 24,26 walls may be pivoted about their respective pivot connections 28,30 in a manner such that the front and rear walls are brought adjacent to each other with the left and right side walls disposed therebetween. In the expanded position, the front and rear walls 20,22 and the left and right side walls 24,26 may be pivoted about their respective pivot connections 28,30 in a manner such that the front and rear walls may spaced apart from one another by the left and right side walls, and such that the left and right side walls are substantially planar and perpendicular to the front and rear walls. In the expanded arrangement, the front and rear walls 20,22, and the left and right side walls 24,26 define an interior of the frame. When the pet bed 10 is in the expanded arrangement, the front and rear walls 20,22, and the left and right side walls 24,26 each have an inward face into the interior of the frame and an outward face opposite the inward face that is exposed. FIGS. 1 and 7 show the pet bed 10 in a collapsed arrangement. FIGS. 3, 4, 5, and 6 show the pet bed in an expanded arrangement.

The front and rear walls 20,22, and the left and right side walls 24,26 each have a top and bottom edge. The top edge of the front wall may have a recess 32 to facilitate egress and ingress of the pet into the pet bed. Although not shown, the other walls may also have such a recess. The frame 12 also has a bottom 34 which is formed from a pliant material. The pliant material may be a fabric, non-woven polymer, or other collapsible or foldable type of material. For instance, the bottom 34 may be formed from a PVC or other liquid impervious liquid material, for instance, a plastic or vinyl sheet material. The bottom 34 may be attached to the bottom edges of the front and rear walls 20,22 and extend therebetween. The bottom may also be attached to the bottom edges of the left and right side walls and extend therebetween. The bottom 34 may have its corners 36 cut out to form an opening in the corners of the frame adjacent to the bottom edge. As will be explained below in greater detail, the cutout corners 36 may be used to allow the cover to be fastened to the pet bed. The pliant bottom 34 allows the frame to be collapsed when the front and rear walls 20,22 are brought adjacent to each other with the left and right side walls 24,26 disposed therebetween. In the collapsed arrangement of the pet bed 10, the bottom 34 may be folded between the front and rear walls 20,22, or folded against an outward face of either of the front and rear walls. The bottom has an inward face into the interior of the frame and an outward face opposite the interior face.

The pet bed cover 14 is configured to attach to and be released from the pet bed. Providing a releasably attachable cover 14 allows the cover to be removed from the pet bed and laundered. The releasably attachable cover 14 allows the cover to be replaced when worn or changed for decorative purposes. The cover may be formed from a pliant material, and may remain attached to the pet bed in either the collapsed or expanded arrangement. For instance, it is not necessary to remove the cover from the pet bed to move the pet bed from the expanded arrangement to the collapsed arrangement. As the cover 14 is made from a pliant material, the cover may conform to the frame 12 and be folded therewith when the frame is moved to the collapsed arrangement. The cover 14 may be formed from a quilted or padded material. The cover may have a front panel 40, a rear panel 42, and left and right side panels 44, 46 connected to each other to comprise a rectangular cross section, tube-shaped member. The cover's panels 40,42,44,46 may generally match with the respective front and rear walls 20,22, and the left and right side walls 24,26 of the frame. The cover may also have a bottom panel 48 which corresponds to the bottom 34 of the frame. When the cover 14 is formed as a tube with the bottom panel 48, the bottom panel extends across one end of the tube and the opposite end of the tube is left open to allow the frame 12 to be inserted in the cover with the outward face of the frame bottom 34 abutting the cover bottom panel 48. When the cover is formed as a tube without a bottom panel, the cover may be positioned around the frame or the frame may be inserted in the cover. The cover bottom panel 48 may have an outward face with non-skid material. The bottom panel 48 may also be formed from a liquid impervious material. The cover 14 may also have a pet access 52 opening corresponding to the recess 32 of the front, rear, left and/or right side walls, to allow access of a pet into the pet bed. As shown in the drawings, the pet access opening 52 of the cover is provided on the cover front panel 40 to correspond to the recess 32 of the frame front wall 20. While the cover is shown with left and right panels and front and rear panels that generally cover the entirety of each of the frame front, rear, left and right side walls, the cover may have less than four panels, so that, for instance, the cover may only cover one of the four walls, such as the front wall, the rear wall, a side wall; or two walls of the four walls, such as the front and rear wall, or the left and right side walls; or three of the four walls. The cover may also be configured to partially cover the inward face and/or outward face of a wall of the frame.

FIG. 2 shows the cooperative relationship of the frame 12 and the cover 14. The cover 14 may be arranged with the cover bottom panel 48 resting on a support surface and the opposite open end extended upward to receive the frame 12. The frame 12 may be manipulated to an intermediate position between the expanded and collapsed arrangement of the frame to allow the frame to be inserted within the cover 14. The frame may be positioned such that the frame bottom 34 is adjacent the cover bottom panel 48 and the frame front and rear walls 20,22, and the frame left and right side walls 24,26 are positioned to be aligned with the cover front and rear panels 40,42, and the cover left and right side panels 44,46. With the frame 12 received in the cover 14 and resting on the support surface, the cover 14 may be folded over the top edges of the frame front and rear walls 20,22 and the frame left and right side walls 24,26. For purposes of facilitating the description that follows and to provide a visual aid in the drawings to illustrate the assembly of the cover 14 with the frame 12, a fold line 54 is shown on the cover of FIG. 2. As the cover 14 is made from a pliant material, the cover may easily fold over the top edge of the frame. For ease of illustration, as shown in the drawings, the cover fold line 54 corresponds with the vertical height of the frame such that when the frame is installed in the cover, the fold line corresponds to the top edges of the frame front and rear walls 20,22, and the frame left and right side walls 24,26. The cover 14 may be folded over the fold line 54 such that a portion of the cover extends over the inward face of the front and rear walls 20,22 and the left and right side walls 24,26. The cover 14 also extends over the outward face of the front and rear walls 20,22 and the left and right side walls 24,26. FIG. 3 shows further detail of the cover extending over the frame. The pet access opening 52 in the cover may be arranged to correspond with the recess 32 in the front wall 20.

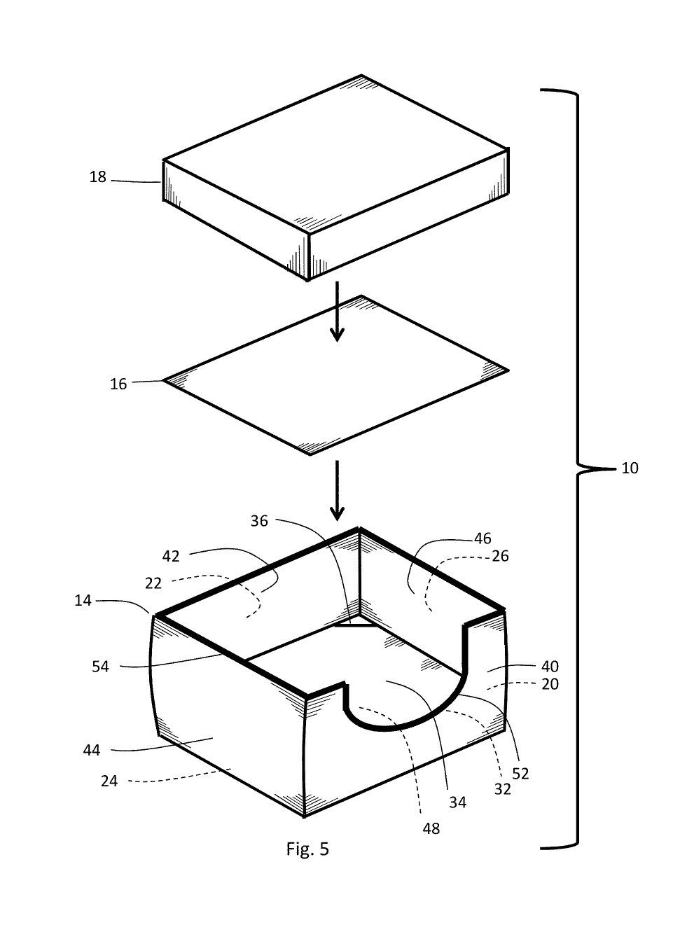

FIG. 4 shows additional detail of one embodiment of releasably attaching the cover 14 to the pet bed. One or more of the panels 40,42,44,46 of the cover 14 may have a snap attachment 60 at its upper edge adjacent the open end of the cover opposite the bottom panel 48, and a complementary snap attachment 62 on the bottom panel. When the cover 14 is assembled with the frame 12, the complementary snap attachment of the cover bottom panel 48 may be arranged in the cut-out 36 of the bottom 34 of the frame. When the cover 14 is pivoted about the fold line 54 into the interior of the pet frame, the snap 60 on the upper edge of the cover 14 may be brought in close proximity to the cut-out 36 formed in the corner of the bottom 34 of the frame 12, and brought into register with the complementary snap attachment 62 of the cover bottom panel 48. The snap attachments 60,62 may be connected, thereby allowing the cover to be releasably attached to the pet bed. In this way, the cover may be attached to itself in removably attaching the cover to the pet bed. In the alternative, the frame may have mechanical fasteners on the inward and/or outward faces of the walls that cooperate with mechanical fasteners of the cover to allow the cover to be releasably attached to the pet bed, e.g. hook and loop material, snaps, hooks, clips, buttons and loops, ties, etc.

FIG. 5 shows an exploded view of the pet bed 10 including the base 16 and the cushion 18. To maintain the front and rear side walls 20,22, and the left and right side walls 24,26 in the expanded arrangement and generally perpendicular to each other, the base 16 may be inserted adjacent the frame bottom 34. The base 16 may be dimensioned so as to maintain the front and rear walls 20,22 in a spaced-apart relationship generally equal to the length of the left and right side walls 24,26. It is not necessary that the base extend between the left and right side walls although the base may to provide sufficient rigidity and maintain the left and right side walls and front and rear side walls in an upstanding, perpendicular manner. Likewise, it is not necessary that the base extend between the front and rear walls although the base may to provide sufficient rigidity and maintain the left and right side walls and front and rear side walls in an upstanding, perpendicular manner. The base may or may not have cut-outs in its corners corresponding to the cut-outs of the frame bottom. The cushion 18 may also be disposed in the interior of the frame to provide comfort for the pet. While the drawings show the cushion and base as separate components, the base may be integrated with the cushion.

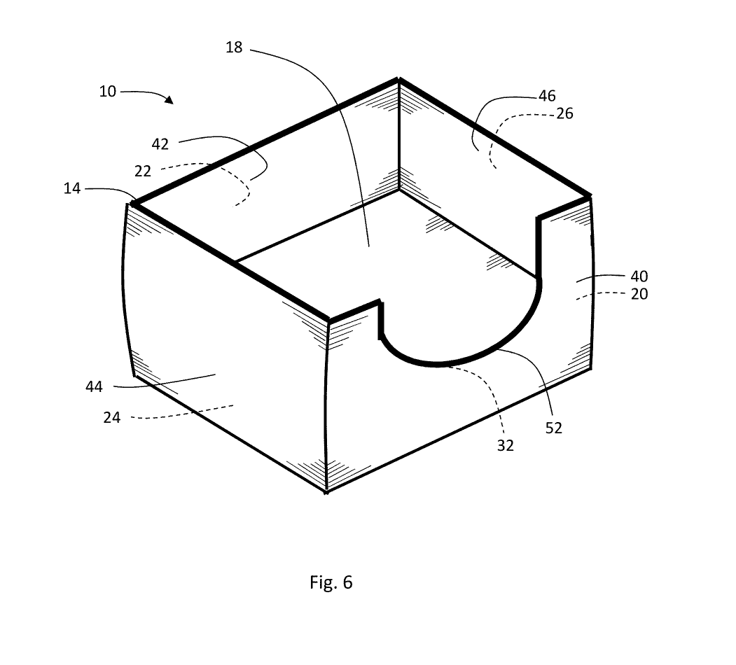

FIG. 6 shows a fully assembled pet bed 10 with the cover 14 extending over the frame 12, and the cushion 18 and the base 16 inserted in the interior of the frame. To disassemble the pet bed 10, the components 12,14,16,18 may be removed in the order in which they were inserted. In other words, the cushion 18 may be removed from the interior of the frame, and then the base 16 may be removed from the interior of the frame. The cover 14 may be releasably attached from the pet bed to allow the frame 12 to be moved from the expanded arrangement to a partially collapsed arrangement, thereby allowing the frame to be removed from the cover through the cover opening. Once the frame 12 is removed from the cover opening, the frame may be moved to the fully collapsed arrangement. The cover 14 may then be folded for storage.

FIG. 7 shows an embodiment where the cover 14 is folded over itself so as to approximate the dimensions of the frame 12. The base 16 and the cushion 18 may also have dimensions which approximate that of the frame 12, thereby allowing the components 12,14,16,18 to be stacked side-by-side and compressed into a carrying tote 60 for portability.

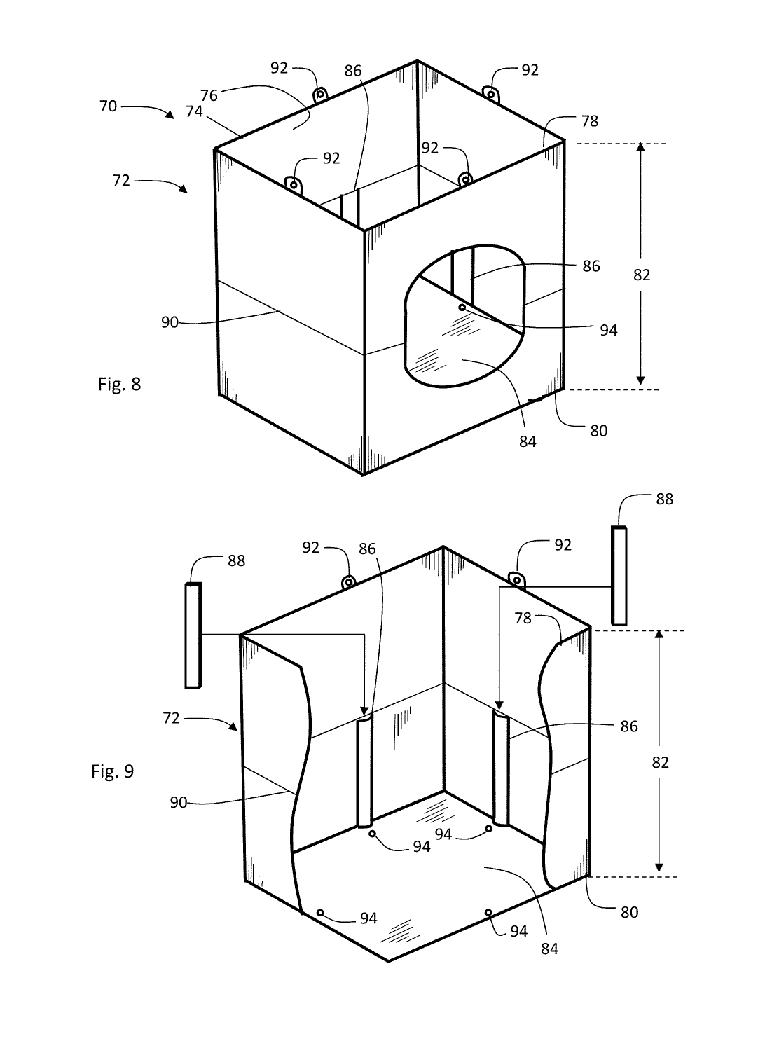

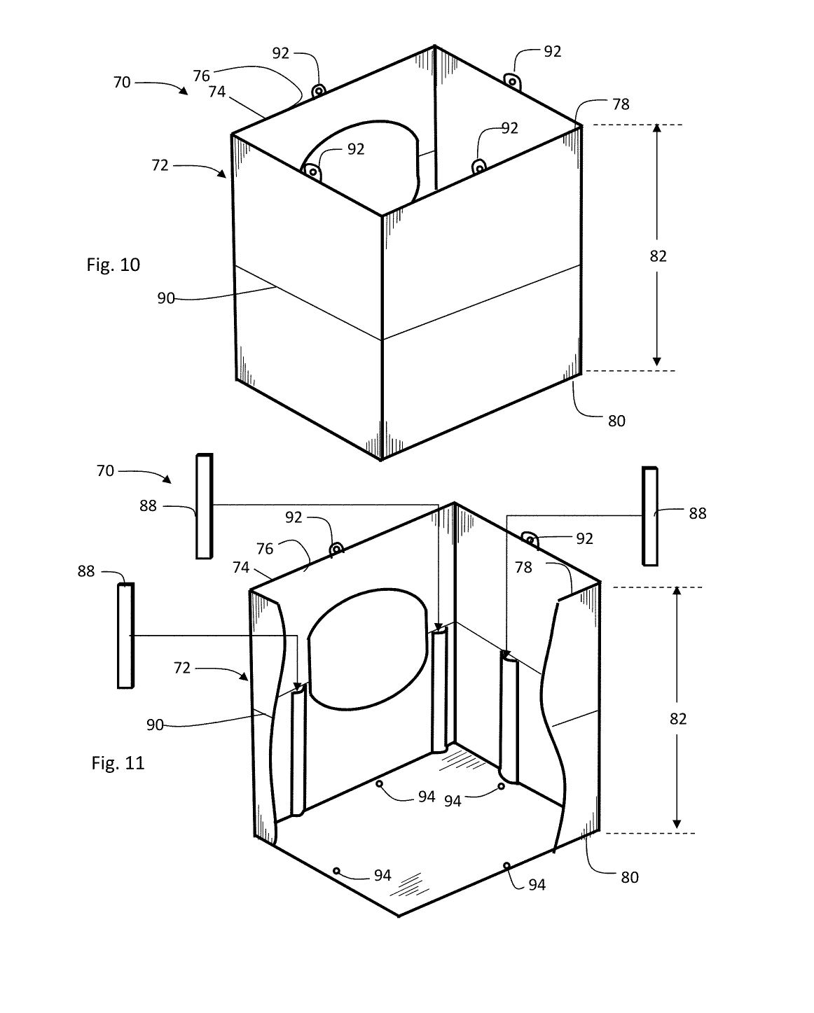

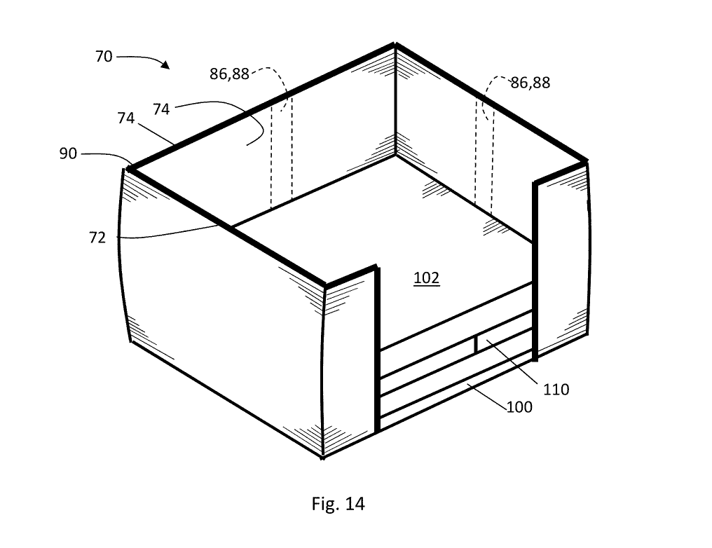

FIGS. 8 through 14 show other embodiments of a collapsible pet bed 70. The pet bed 70 comprises a pliant material 72 with first and second surfaces 74,76. As described below in greater detail, the pliant material 72 may be arranged to form an upstanding wall for at least a partial enclosure for the pet bed 70 (a full enclosure is shown in FIGS. 8-13 and a partial enclosures is shown in FIG. 14). The pliant material 72 may be configured as a tube where one of the first and second surfaces 74 defines the outer surface of the tubular member and the other of the first and second surfaces 76 defines the inner surface and interior of the tubular member. The tubular member may have a cross-section resembling a circle, triangle, square, rectangle, hexagon, octagon, or another shape. The tubular member may have axially opposite first and second ends 78,80 spaced apart by a length 82. The first end 78 may form an opening into the interior of the tubular member. The second end 80 may have a bottom panel 84 attached thereto. The bottom panel 84 may be formed from a pliant material to allow the pet bed to be collapsed.

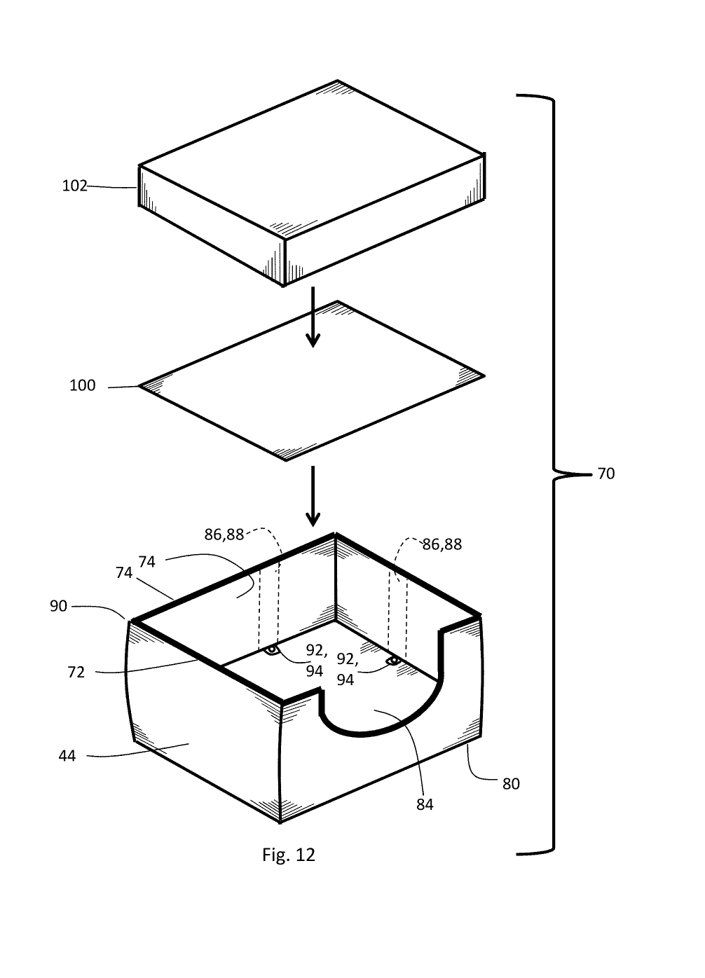

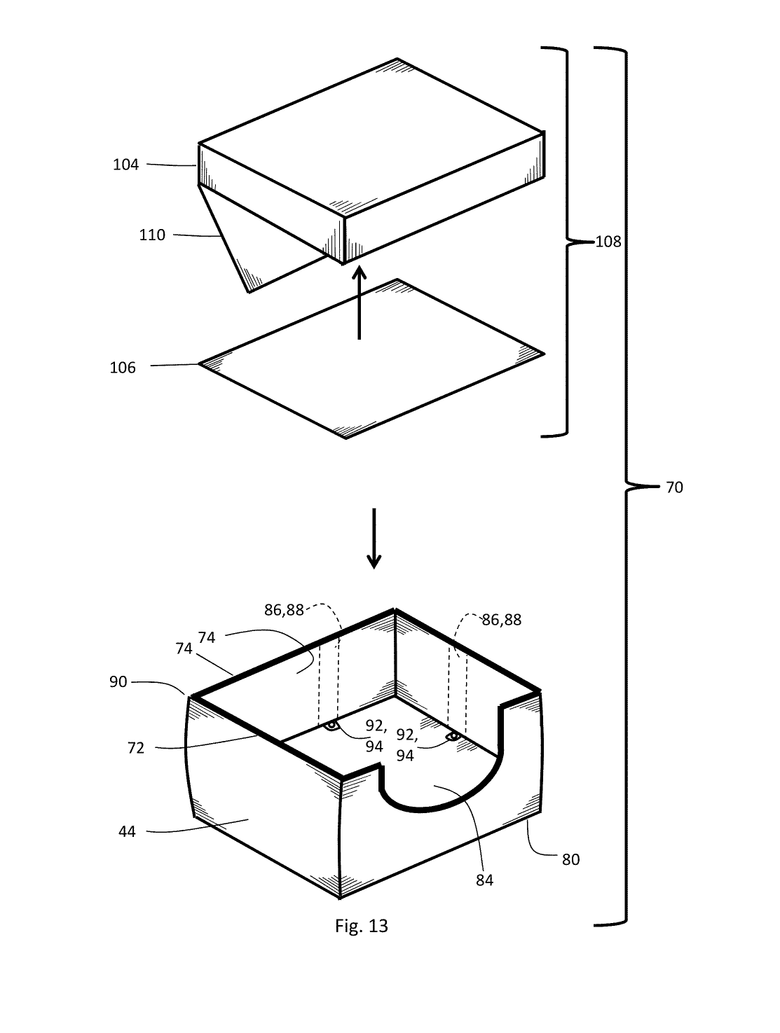

The tubular member may have stay attachment members 86 configured to receive rigid stays 88. As shown in FIGS. 8-11, the stay attachment members 86 are provided on the inner surface 76 of the tubular member. Thus, in forming the pet bed shown in FIGS. 12-13, the tubular member may be folded over itself with first end 78 folded into the interior of the tubular member such that a portion of the outer surface 74 of the tubular member forms an interior of the pet bed and another portion of the outer surface 74 of tubular member forms the outward facing, exterior of the pet bed. Portions of the second surface 76, e.g., the inner surface, face each other inside the folds. In the embodiment shown in FIGS. 8-11, the tubular member is folded over itself and over the stays 88 in the stays attachment members 86 so as to conceal and secure the stays in the stay attachment members between the folds of the tubular member. While the drawings show the stay attachments members on the inner surface of the tubular member, the stay attachment members may also be provided on the outer surface of the tubular member such that the tubular member outer surface may be folded outward over the stays in the stay attachment members so as to obscure and secure the stays in the stay attachment members between the folds. In this arrangement, a portion of the inner surface 76 of the tubular member defines the interior of the pet bed and another portion of the inner surface of the tubular member defines the outward facing, exterior of the pet bed. Portions of the first surface 74, e.g., the outer surface, face each other inside the folds.

Although the drawings shown the pliant material 72 in the tubular configuration forming the upstanding wall for the enclosure of the pet bed, the pliant material may also comprise a generally rectangular sheet which may be arranged as the upstanding wall for at least a partial enclosure of the pet bed. When the pliant material comprises a sheet, the pliant material may be folded over itself in a manner such that a portion of the pliant material first surface forms an interior of the pet bed, another portion of the pliant material first surface defines an exterior of the pet bed, and portions of the pliant material second surface face each other. Stay attachment member may be provided on one of the first and second surfaces. The pliant material may be folded over itself so as to obscure and secure the stays in the stay attachment members between the folds of the pliant material. The stays support the folded over portions in an upstanding wall configuration. The upstanding wall configuration may then be forming into a tube like structure to form at least a partial enclosure of the pet bed (FIG. 14).

The stay attachment members 86 are spaced about the pliant material 72 as necessary to provide structural integrity for the pliant material when arranged as the upstanding wall for pet bed. As shown in the drawings, the stay attachment members 86 comprise sleeves attached to the pliant material. The stay attachment members may also comprise spaced apart loops attached to the pliant material 72 along the length 82 or channels within the pliant material. The stay attachment members 86 are sized to allow stays 88 to be inserted and removed for assembly and collapsing of the bed. The stays 88 may comprise rectangular inserts formed from a rigid material such as plastic or wood. The stay attachment members 86 may extend from an intermediate position on the length 82 on the pliant material 72 to the second end 80. As shown in the drawings, the stay attachment members 86 extend from a mid-point of the pliant material 72 to the second end 80 such that when the pliant material is folded over itself and the first end 78 is brought adjacent the second end, the stay attachment member 86 extends along the entire resultant upstanding wall. The stay attachment members 86 may extend generally in the same direction as the pliant material length 82 so as to provide a generally upstanding wall when the pliant material 72 is folded over itself. A fold line 90 is shown in the drawings to provide a reference where the pliant material 72 may be folded over itself and doubled over. The fold line may be provided in the pliant material to facilitate folding.

The pliant material 72 may be releasably attached itself. As shown in the drawings, the pliant material first end 78 may be releasably attached to the bottom panel 84 extending across the pliant material second end 80. The pliant material 72 may have snaps, ties, loops, or hook and loop material to provide a releasable attachable connection. For instance, as show in the drawings, the pliant material first end 78 has snaps 92, which releasably engage complementary snaps 94 on the bottom panel 84. Depending upon the arrangement of the stay attachment members 86—for example, on the inner surface of the tubular member or outer surface of the tubular member, and thus, whether the pliant material first end 78 is folded inward into the interior of the pet bed or outward—the complementary releasable fasteners 92,94 may be provided on the bottom panel 84 in the interior of the pet bed or on the exterior of the pet bed, for instance, the underside of the bottom panel.

As shown in FIGS. 12 and 13, a rigid base 100 may be inserted into the interior of the pet bed to maintain the folded over pliant material 72 in an upstanding wall arrangement with a spaced apart interior forming at least a partial enclosure of the pet bed. In FIG. 12, the rigid base 100 may be disposed in the interior of the pet bed adjacent to the bottom panel 84 and a cushion 102 may be provided in the interior of the pet bed adjacent the rigid base 100 to provide comfort for the pet. As shown in FIG. 13, the cushion 104 and rigid base 106 may be assembled to form an integral unit 108. For instance, as shown in FIG. 13, the cushion has a removable bottom panel 110. The rigid base 106 may be inserted into and removed from the cushion 104 from the removable bottom panel 110. The cushion 104 may also have a compartment to receive the rigid base 106. The rigid base 106 may also be releasably secured to the cushion 104 with snaps, hook and loop material, loops, ties, etc. The integral unit 108 may then be inserted into the interior of the pet bed.

Although the drawings show the pliant material 72 having the bottom panel 84 at the second end 80, the bottom panel may be omitted and the pliant material may be configured to form the upstanding wall with the rigid base and cushion resting on a support surface, for instance, the floor, within the interior of the at least partial enclosure formed by the upstanding wall. Also, although FIGS. 8-13 show the pliant material formed as a tubular member and arranged into the upstanding wall, the pliant material may be folded over and secured to itself to form or approximate a tubular member to form a partial enclosure, for instance, as shown in FIG. 14. The partial enclosure may be supported by straps 110 or other fasteners. The pliant material may also comprise inner and outer layers of pliant material, and the stay attachment members may be provided on the plaint member between the inner and outer layers.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method of forming a pet bed comprising:
providing a pliant material with first and second surfaces, the pliant material second surface having a plurality of stay attachment members disposed thereon;
inserting stays in the stay attachment members; and
arranging the pliant material in a manner to form an upstanding wall for at least a partial enclosure with the pliant material folded over itself in a manner such that (i) one portion of the pliant material first surface faces the interior of the pet bed, (ii) another portion of the pliant material first surface defines the exterior of the pet bed, (iii) portions of the pliant material second surface face each other, and (iv) the stays support the wall in an upstanding configuration.

2. The method of claim 1, further comprising inserting a base into the pet bed interior.

3. The method of claim 1 further comprising inserting a cushion into the pet bed interior adjacent to the base.

4. The method of claim 1, further comprising:
assembling a base with a cushion;
inserting the assembled base and cushion into the interior.

5. The method of claim 1, wherein the step of providing pliant material includes providing the pliant material as a tubular member with axially opposite sides.

6. The method of claim 5, wherein the step of arranging the pliant material includes folding one axial side into an interior of the tubular member toward the other axial side.

7. The method of claim 5, wherein step of providing the pliant material as the tubular material comprises providing the stay attachment members on an inner surface of the tubular member.

8. The method of claim 1, wherein the step of arranging the pliant material to form the upstanding wall includes folding the pliant material end over ends of the stays in the attachment members.

9. The method of claim 5, wherein step of providing the pliant material as the tubular material comprises providing a bottom panel on one axial side.

10. The method of claim 9, further comprising releasably securing the side of the tubular member axially opposite the bottom panel to the bottom panel.

11. A pet bed comprising an upstanding wall formed from a pliant material and forming at least a partial enclosure defining an interior of the pet bed, the upstanding wall having inner and outer layers, the inner and outer layers each having first and second surfaces, the inner layer first surface being adjacent to the outer layer first surface, the inner layer second surface facing the interior of the pet bed, the outer layer second surface defining an exterior of the pet bed, the upstanding wall having first and second ends spaced apart to define a height for the upstanding wall, the first end forming an opening in the interior of the pet bed, one of the inner layer first surface and the outer layer first surface having a plurality of stay attachment members with stays disposed within the stay attachments members, the stay attachment members extending from the upstanding wall second end and generally transverse to the upstanding wall second end, and supporting the wall in the upstanding configuration.

12. The pet bed of claim 11, further comprising a base disposed in the pet bed interior.

13. The pet bed of claim 11, further comprising a cushion disposed in the pet bed interior adjacent to the base.

14. The pet bed of claim 11, further comprising a cushion having a rigid base integral therewith disposed in the pet bed hollow interior.

15. The pet bed of claim 11, wherein the stay attachment members comprise sleeves.

16. The pet bed of claim 11, wherein the stays extend substantially axially along a portion of the upstanding wall height.

17. The pet bed of claim 11, wherein upstanding wall comprises a tubular member with first and second sides, and tubular member is folded over itself such that a portion of the tubular layer first side forms the inner layer second side and another portion of the tubular layer first side forms the outer layer second side, and a portion of the tubular layer second side forms the inner layer first side and another portion of the tubular layer second side forms the outer layer first side.

18. The pet bed of claim 17, wherein the upstanding wall has a bottom panel at the second end of the upstanding wall.

19. The pet bed of claim 18, wherein the folded over portion of the tubular member is releasably secured to the bottom panel.

20. The pet bed of claim 11, wherein the stay attachment members are disposed on the outer layer first surface.

21. A pet bed comprising an upstanding wall formed from a pliant material, the upstanding wall having an inner layer with first and second surfaces and an outer layer with first and second surfaces, the inner layer and outer layer being side by side each other with the inner layer first surface facing the outer layer first surface, the inner layer second surface defining an interior of the pet bed, the outer layer second surface defining an exterior of the pet bed, the upstanding wall having axially opposite first and second ends spaced apart by a height of the upstanding wall, the upstanding wall first end forming an opening in the interior of the pet bed, one of the outer layer first surface and inner layer first surface having a plurality of stay attachment members with stays disposed within the stay attachments, and supporting the wall in the upstanding configuration.

22. The pet bed of claim 21, further comprising a bottom panel attached to the upstanding wall second end.

23. The pet bed of claim 22, wherein the inner layer is releasably secured to the bottom panel.

24. The pet bed of claim 21, wherein the inner layer and outer layer are formed from a unitary piece of the pliant material.

25. The pet bed of claim 21, wherein the inner layer and outer layer together form a tube shaped member.

26. The pet bed of claim 21, wherein the outer layer first surface includes the stay attachment members.
